(19) United States
(12) Patent Application Publication
(10) Pub. No.: US 2007/0161724 A1
(43) Pub. Date: Jul. 12, 2007

(54) Copolymers based on unsaturated mono-or dicarboxylic acid derivatives and oxyalkyleneglycol-alkenyl ethers, method for the production and use thereof

(76) Inventors: Bogdan Moraru, Rosenheim (DE); Christian Hubsch, Gmund (DE); Gerhard Albrecht, Tacherting (DE); Stefanie Scheul, Trostberg (DE); Eva Hetzlsperger, Unterneukirchen (DE)

Correspondence Address: FULBRIGHT & JAWORSKI, LLP, 666 FIFTH AVE, NEW YORK, NY, 10103-3198, US

(21) Appl. No.: 10/588,041

(22) PCT Filed: Feb. 3, 2005
(86) PCT No.: PCT/EP05/01087

§ 371 Date: Aug. 1, 2006

(30) Foreign Application Priority Data
Feb. 4, 2004 (DE) 10 2004 005 434.7

(51) Int. Cl. C08L 95/00

(52) U.S. Cl. 524/59; 524/2; 524/423; 526/264; 526/319; 526/303.1; 526/287; 526/274; 526/266

(57) ABSTRACT

The invention relates to copolymers based on unsaturated mono or dicarboxylic acid derivatives, oxyalkyleneglycol-alkenyl ethers, vinyl polyalkyleneglycol or ester compounds, in addition to the use thereof as additives for aqueous suspensions base don mineral or bituminous binding agents. Said invention is characterized in that the inventive copolymers, having a long lateral chain, impart small amounts of excellent processing properties to aqueous binding suspension, and simultaneously cause the water content in the concrete to be greatly reduced.

The present invention relates to copolymers based on unsaturated mon- or dicarboxylic acid derivatives and oxyalkyleneglycol alkenyl ethers, to processes for the production thereof and to the use of these copolymers as additives for aqueous suspensions based on mineral or bituminous binders.

The frequent addition of additives in the form of dispersing agents to aqueous suspensions of hydraulic binders is known to improve the processability thereof, i.e. kneadability, slumpability, sprayability, pumpability or flowability. These additives which usually contain ionic groups are capable of breaking up solid agglomerated material, dispersing the resulting particles and thus improving the processability specifically of highly concentrated suspensions. This effect is specifically utilised in the production of building material mixtures based on cement, lime and hydraulic binders based on calcium sulphate optionally also admixed with organic (for example bituminous) fractions and also for ceramic materials, refractory materials and oilfield building materials.

In order to convert these building material mixtures based on the aforementioned binders into a processable form which is ready for use, substantially more mixing water is generally necessary than would be required for the subsequent hydration or setting process. The hollow proportion of the main body formed by the excess water which later evaporates results in significantly impaired mechanical strength and resistance values.

In order to reduce this excess quantity of water with a predetermined processing consistency and/or to improve the processability where there is a predetermined water/binder ratio, additives are used which are generally termed water-reducing agents or fluidizers. Polycondensation products based on naphthalene or alklynaphthalene sulponic acids (cf. EP-A 214 412) or melamine formaldehyde resins containing sulphonic acid groups (cf. DE-PS 16 71 017) are predominantly known as agents of this type.

A disadvantage of these additives is the fact that the excellent liquefying action of which, particularly in concrete construction, only lasts for a short period of time. The reduction in processability of concrete mixtures (“slump-loss”) within a short time can lead to problems particularly where there is a long time interval between production and laying of the ready-mixed concrete, for example conditioned by long conveying and transportation distances.

An additional problem arises from the use of such fluidizers in the mining industry and in the internal field (gypsum plasterboard drying, anhydrite screed applications, production of precast concrete parts), where the toxic formaldehyde contained in the products due to production may be released, and thus workers' health may be seriously affected. It was for this reason that attempts have already been made to instead develop formaldehyde-free concrete fluidizers from maleic acid monoesters and styrene, for example according to EP-A 306 449. It is possible to maintain the flow action of concrete mixtures for a sufficiently long period of time using these additives, although the originally present, very high dispersing effect is lost very rapidly after storing the aqueous preparation of the fluidizer, caused by the hydrolysis of the polymeric ester.

This problem does not occur in the case of fluidizers consisting of alkylpolyethleneglycol allyl ethers and maleic acid anhydride corresponding to EP-A 373 621. However, these products, as in the case as those described above, are surface-active compounds which introduce, in an undesired manner, large quantities of air voids into the concrete mixture, thereby resulting in a loss in the completeness and resistance of the hardened building material.

Thus, it is necessary to add to the aqueous solutions of these polymer compounds antifoam agents, for example tributylphosphate, silicone derivatives and various water-insoluble alcohols in a concentration range of from 0.1 to 2% by weight, based on the solids content. Mixing in these components and maintaining a homogeneous form, which is stable in storage, of the corresponding formulations proves to be extremely difficult even when these antifoam agents are added in the form of emulsions.

It is possible to solve the problem of separation according to DE 195 13 126 A1 by the complete or at least partial incorporation of a defoaming or non-air introducing structural unit into the copolymer.

It has been found, however, that the high efficiency and the low “slump-loss” of the copolymers described here often results in unsatisfactory 24 hour strengths of the concrete. Moreover, copolymers of this type do not exhibit the optimum properties particularly in cases in which a particularly tightly joined, and thus high-strength and highly resistant, concrete is to be produced with the smallest quantity of water possible and in which the intention is to dispense with steam curing (prefabricated materials industry) in order to accelerate the hardening process.

To solve this problem, DE 199 26 611 A1 proposed copolymers of unsaturated mono- or dicarboxylic acid derivatives and oxyalkyleneglycol alkenyl ethers which are able to maintain, for a period of time which meets practical requirements, the processability of highly concentrated building material mixtures with low metering, for a strength, increased simultaneously by an extreme reduction in the water/binder ratio, in the hardened state of the building material. However, it has proved to be a disadvantage of these copolymers with relatively short side chains that the early strength development of the corresponding building material mixtures was less than optimum.

The present invention is therefore based on the object of providing new copolymers which do not have the aforementioned disadvantages of the prior art, i.e., they are able to maintain the processability of highly concentrated building material mixtures with a low dosing for a period of time which meets practical requirements and simultaneously provide the corresponding building materials with such high strength values after only a few hours that it is possible to remove the formworks at an early stage and thus to reduce the cycle times in the production of concrete parts in the casting plant or to significantly accelerate progress on the building site.

This object was achieved according to the invention by the copolymers corresponding to claim 1. In particular, it has surprisingly been found that the products according to the invention based on unsaturated mono- or dicarboxylic acid derivatives and oxyalkyleneglycol alkenyl ethers with long side chains provide aqueous binder suspensions with outstanding processing properties when added in the smallest amount and simultaneously cause a high water reduction in the concretes. It was particularly surprising that it is possible due to the extremely rapid development of strength to remove the concrete formworks after unexpectedly short times and thus to drastically increase the economic efficiency in concrete construction.

The copolymers according to the present invention contain at least three, but preferably four structural groups a), b), c) and d). The first structural group a) is a mono- or dicarboxylic acid derivative with the general formula Ia, Ib or Ic.

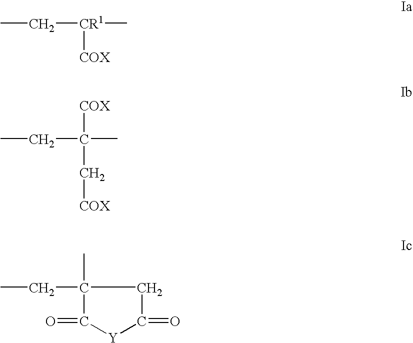

In the case of the monocarboxylic acid derivative Ia, R¹ represents hydrogen or an aliphatic hydrocarbon radical having from 1 to 20 C atoms, preferably a methyl group. X in the structures Ia and Ib represents —OMₐ and/or —O—(CₘH₂ₘO)ₙ—R² or —NH—(CₘH₂ₘO)ₙ—R² wherein M, a, m, n and R² represent the following:

M represents hydrogen, a mono- or divalent metal cation (preferably sodium, potassium, calcium or magnesium ion), ammonium, an organic amine radical and a=½ or 1, depending on whether M represents a mono- or divalent cation. Used as organic amine radicals are preferably substituted ammonium groups derived from primary, secondary or tertiary C₁₋₂₀-alkylamines, C₁₋₂₀ alkanolamines, C₅₋₈ cycloalkylamines and C₈₋₁₄ arylamines. Examples of the corresponding amines include methylamine, dimethylamine, trimethylamine, ethanolamine, diethanolamine, triethanolamine, methyldiethanolamine, cyclohexylamine, dicyclohexylamine, phenylamine and diphenylamine in the protontated (ammonium) form.

R² represents hydrogen, an aliphatic hydrocarbon radical having from 1 to 20 C atoms, a cycloaliphatic hydrocarbon radical having from 5 to 8 C atoms, an aryl radical having from 6 to 14 C atoms which may optionally be substituted, m=2 to 4 and n=0 to 200. The aliphatic hydrocarbon radicals may in this case be linear or branched and saturated or unsaturated. Cyclopentyl or cyclohexyl radicals are considered as preferred cycloalkyl radicals and phenyl or naphthyl radicals which may be substituted in particular by hydroxyl, carboxyl or sulphonic acid groups are considered as preferred aryl radicals.

Instead of, or in addition to, the dicarboxylic acid derivative according to formula Ib, the structural group a) (mono- or dicarboxylic acid derivative) may also be present in cyclical form corresponding to formula Ic, wherein Y═O (acid anhydride) or NR² may represent (acid imide) with the meaning denoted above for R².

The second structural group b) corresponds to formula II 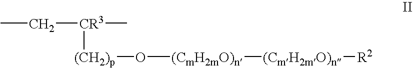
and is derived from oxyalkyleneglycol alkenyl ethers, wherein m′ represents 2 to 4, n′+n″ represent 250 to 500 and p represents 0 to 3 and R² and m respectively have the meaning provided above.

R³ again represents hydrogen or an aliphatic hydrocarbon radical having from 1 to 5 C atoms which may also be linear or branched or unsaturated.

According to the preferred embodiments, in formulae Ia, Ib and II, m represents 2 and/or 3, so that polyalkylene oxide groups are concerned derived from polyethylene oxide and/or polypropylene oxide. Moreover, in formula Ia, n may represent in particular 1 to 150. In a further preferred embodiment, p in formula II represents 0 or 1, i.e. vinyl- and/or allylpolyalkoxylates are concerned. In formula II, p particularly preferably represents 0 and m represents 2.

The third structural group c) corresponds to formula IIIa or IIIb

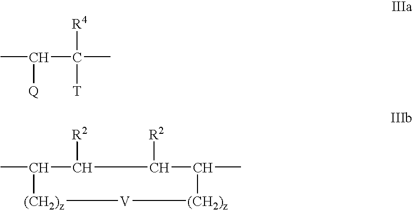

In formula IIIa, R⁴ may represent H or CH³, depending on whether acrylic acid or methacrylic acid derivatives are concerned. In this formula, Q may represent —H, —COOMₐ or —COOR⁵ wherein a and M have the aforementioned meaning and R⁵ may be an aliphatic hydrocarbon radical having from 3 to 20 C atoms, a cycloaliphatic hydrocarbon radical having from 5 to 8 C atoms or an aryl radical having from 6 to 14 C atoms. The aliphatic hydrocarbon radical may also be linear or branched, saturated or unsaturated. The preferred cycloaliphatic hydrocarbon radicals are again cyclopentyl or cyclohexyl radicals and the preferred aryl radicals are phenyl or naphthyl radicals. When T=—COOR⁵, Q represents —COOMₐ or —COOR⁵. When T and Q=—COOR⁵, the corresponding structural groups are derived from the dicarboxylic acid esters.

The structural groups c) may also contain other hydrophobic structural elements in addition to these ester structural units. Included among these are the polypropylene oxide or polypropylene oxide-polyethylene oxide derivatives wherein 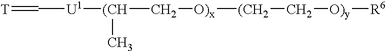
x assumes a value from 1 to 150 and y a value from 0 to 15. The polypropylene oxide (polyethylene oxide) derivatives may in this case be linked via a grouping U¹ with the ethyl radical of structural group c) corresponding to formula IIIa, wherein U¹═—CO—NH—, —O— or may be —CH₂—O—. In this case, the corresponding amide-, vinyl- or allylether of the structural group corresponding to formula IIIa is concerned. R⁶ may again be R² (see above meaning of R²), or 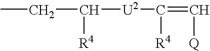
wherein U²═—NH—CO—, —O—, or may represent —OCH₂— and Q may have the meaning described above. These compounds are polypropylene oxide(-polyethylene oxide) derivatives of the bifunctional alkenyl compounds corresponding to formula IIIa.

As further hdroyphobic structural elements the structural groups c) may also contain compounds according to formula IIIa wherein T=(CH₂)_{z}—V—(CH₂)_{z}—CH═CH—R², wherein z=0 to 4 and V may be a —O—CO—C₆H₄—CO—O radical and R² has the aforementioned meaning. In this case these are the corresponding difunctional ethylene compounds according to formula IIIa which are linked together via ester groupings of formula —O—CO—C₆H₄—CO—O and wherein only one ethylene group was copolymerised. These compounds are derived from the corresponding dialkenyl-phenyl-dicarboxylic acid esters.

It is also possible within the scope of the present invention that not only one, but both ethylene groups of the difunctional ethylene compounds were copolymerised. This substantially corresponds to the structural groups corresponding to formula IIIb 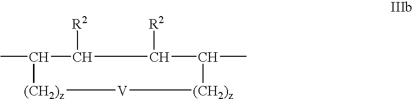
wherein R², V and z have the previously described meaning.

The fourth structural group d) is derived from an unsaturated dicarboxylic acid derivative of the general formula IVa and/or IVb. 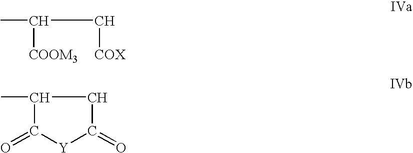
with the aforementioned meaning from a, M, X and Y.

It is to be considered as being fundamental to the invention that the copolymers contain from 25 to 98.99 mol % of structural groups of formula Ia and/or Ib and/or Ic, from 1 to 48.9 mol % of structural groups of formula II, from 0.01 to 6 mol % of structural groups of formula IIIa and/or IIIb and from 0 to 60 mol % of structural groups of formula IVa and/or IVb.

These polymers preferably contain from 70 to 94.98 mol % of structural groups or formula Ia and/or Ib, from 5 to 25 mol % of structural groups of formula II, from 0.02 to 2 mol % of structural groups of formula IIIa and/or IIIb and from 0 to 24.98 mol % of structural groups of formula IVa and/or IVb.

According to a preferred embodiment, the copolymers of the invention also contain up to 50 mol %, in particular up to 20 mol % based on the total of structural groups a) to d), of structures which are based on monomers based on vinyl- or (meth)acrylic acid derivatives, such as styrene, α-methylstyrene, vinylacetate, vinylpropionate, ethylene, propylene, isobutene, N-vinylpyrrolidone, allylsulphonic acid, methallylsulphonic acid, vinylsulphonic acid or vinylphosphonic acid.

Preferred monomeric (meth)acrylic acid derivatives include hydroxyalkyl(meth)acrylates, acrylamide, methacrylamide, AMPS, methylmethacrylate, methlyacrylate, butylacrylate or cyclohexylacrylate.

The number of recurring structural units in the copolymers is not restricted. However, it has proved to be particularly advantageous to adjust average molecular weights of from 1,000 to 100,000 g/mol.

The copolymers according to the invention may be produced in different ways. It is fundamental here that from 25 to 98.99 mol % of an unsaturated mono- or dicarboxylic acid derivative, from 1 to 48.9 mol % of an oxyalkylene-alkenyl ether, from 0.01 to 6 mol % of a vinyl polyalkyleneglycol compound or ester compound and from 0 to 60 mol % of a dicarboxylic acid derivative are polymerised using a radical initiator.

Acrylic acid, methacrylic acid, itaconic acid, itaconic acid anhydride, itaconic acid imide and itaconic acid monoamide are preferably used as unsaturated mono- or dicarboxylic acid derivatives forming the structural groups of formula Ia, Ib or Ic.

Instead of acrylic acid, methacrylic acid, itaconic acid and itaconic acid monoamide, the mon- or divalent metal salts thereof may also be used, preferably sodium, potassium, calcium or ammonium salts.

As acrylic, methacrylic or itaconic acid esters, derivatives are predominantly used, the alcoholic component of which is a polyalkyleneglycol of the general formula HO—(CₘH₂ₘO)ₙ—R² wherein R²═H, an aliphatic hydrocarbon radical having from 1 to 20 C atoms, a cycloaliphatic hydrocarbon radical having from 5 to 8 C atoms, an optionally substituted aryl radical having from 6 to 14 C atoms and wherein n=2 to 4 and m=0 to 200.

The preferred substituents on the aryl radical are —OH—, —COO⁻ or —SO₃⁻ groups.

The unsaturated monocarboxylic acid derivatives may be present only as monoesters, whereas in the case of dicarboxylic acid and itaconic acid, diester derivatives are also possible.

The derivatives of formulae Ia, Ib and Ic may also be present as a mixture of esterified and free acids and are used in a quantity of preferably from 70 to 94.98 mol %.

The second component, fundamental to the invention, for the production of the copolymers of the invention is an oxyalkyleneglycol-alkenyl ether which is preferably used in a quantity of from 5 to 25 mol %. In the preferred oxyalkyleneglycol alkenyl ethers corresponding to formula V
CH₂═CR³—(CH₂)ₚ—O—(CₘH₂ₘO)_{n′}—(C_{m′}H_{2m′}O)_{n″}—R² (V)

R³═H or an aliphatic hydrocarbon radical having from 1 to 5 C atoms, m′=2 to 4, n′+n″=from 250 to 500 and p=0 to 3. R², m and n have the aforementioned meaning. In this case, the use of polyethyleneglycolmonovinylether (p=0 and m=2) has proved to be particularly advantageous, wherein n preferably has values between 1 and 50.

As the third component, fundamental to the invention, for introducing the structural group c), from 0.02 to 2 mol % of a vinylpolyalkyleneglycol compound or ester compound are preferably used. As preferred vinyl polyalkyleneglycol compounds, derivatives corresponding to formula VI are used, 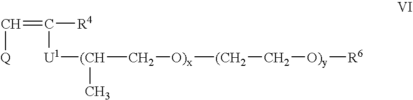
wherein Q may preferably be —H, or —COOMₐ, R⁴═—H, CH₃ and U¹═—CO—NH—, —O— or —CH₂O—, i.e. the acid amide ethers, vinyl ethers or allyl ethers of the corresponding polypropyleneglycol or polypropyleneglycol-polyethyleneglycol derivatives are concerned. The values for x are 1 to 150 and for y are 0 to 15. R⁶ can either again be R² or may represent 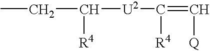
wherein U²═—NH—CO—, —O— and —OCH₂— and Q=—COOMₐ and is preferably —H.

When R⁶═R² and R² preferably represents H, the polypropylene glycol (polyethyleneglycol)-monoamides or ethers of the corresponding acrylic (Q=H, R⁴═H), methacrylic (Q=H, R⁴═CH₃) or maleic acid (Q=—COOMₐ—R⁴═H) derivatives are concerned. Examples of such monomers include maleic acid-N-(methylpolypropyleneglycol) monoamide, maleic acid-N-(methoxy-polypropyleneglycol-polyethyleneglycol) monoamide, polypropyleneglycol vinylether and polypropyleneglycol allylether.

When R⁶≠R², bifunctional vinyl compounds are concerned, the polypropyleneglycol-(polyethyleneglycol) derivatives thereof are linked together via amide or ether groups in (—O— or —OCH₂—). Examples of such compounds include polypropyleneglycol-bis-maleic acid amide, polypropyleneglycoldiacrylamide, polypropyleglycoldimethacrylamide, polypropyleneglycol divinylether and polypropyleneglycoldiallylether.

Derivatives corresponding to the following formula VII are preferably used as a vinylester compound within the scope of the present invention: 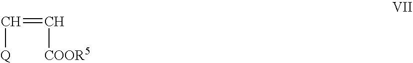
wherein Q=—COOMₐ or —COOR⁵ and R⁵ may be an aliphatic hydrocarbon radical having from 3 to 20 C atoms, a cycloaliphatic hydrocarbon radical having from 5 to 8 C atoms and an aryl radical having from 6 to 14 C atoms. a and M have the aforementioned meaning. Examples of such ester compounds include di-n-butylmaleinate or fumarate or mono-n-butylmaleinate or fumarate.

Furthermore, compounds corresponding to formula VIII may also be used 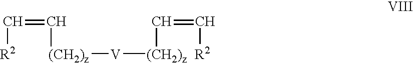
wherein z may again be 0 to 4 and R² has the aforementioned meaning. In this formula, V represents —O—CO—C₆H₄—CO—O—. For example, these compounds are dialkenylphthalic acid derivatives. A typical example of phthalic acid derivatives of this type is diallyphthalate.

The molecular weights of the compounds forming structural group c) may be varied within wide limits and are preferably between 150 and 10,000.

From 0 to 24.98 mol % of an unsaturated dicarboxylic acid derivative IX may preferably be used as the fourth component for the production of the copolymers according to the invention:
MₐOOC—CH═CH—COX IX
with the aforementioned meaning for a, M and X.

When X═OMₐ, the unsaturated dicarboxylic acid derivative is derived from maleic acid, fumaric acid, mono- or divalent metal salts of these dicarboxylic acids, such as the sodium, potassium, calcium or ammonium salt or salts with an organic amine radical. Monomers which are also used and which form the unit Ia are polyalkyleneglycolmonesters of the aforementioned acids with the general formula X
MₐOOC—CH═CH—COO—(CₘH₂ₘO)ₙ—R² X
with the aforementioned meaning for a, m, n and R².

The fourth component may also be derived from the unsaturated dicarboxylic acid anhydrides and imides of the general formula XI 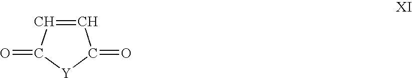
with the aforementioned meaning for Y.

According to a preferred embodiment, up to 50, preferably up to 20 mol %, based on the total of structural groups a) to d), of other monomers may be used according to the invention as described above.

The copolymers according to the present invention may be produced by conventional methods. A particular advantage is that it is possible according to the invention to work without solvent or else in aqueous solution. Both cases involve pressureless and thus safety-related reactions.

If the process is carried out in aqueous solution, polymerisation takes place at from 20 to 100° C. using a conventional radical initiator, the concentration of the aqueous solution preferably being set at 30 to 50% by weight. According to a preferred embodiment, the radical polymerisation may be carried out in the acid pH range, in particular at a pH of between 4.0 and 6.5, wherein the conventional initiators, such as H₂O₂, may be used without resulting in separation of ether as feared, which would have a considerably adverse effect on the yields.

The process according to the invention is preferably carried out so that the unsaturated dicarboxylic derivative forming the structural group d) is introduced in partly neutralised form in aqueous solution, preferably together with the polymerisation initiator and the remaining monomers are added as soon as the receiver reaches the necessary reaction temperature. Added separately are the polymerisation auxiliaries which are able to lower the activation threshold of the preferably peroxidic initiator, so that copolymerisation can take place at relatively low temperatures. According to another preferred embodiment, the unsaturated dicarboxylic acid derivative as well as the radical former may also be added in separate or joint inlets of the reactor receiver, which ideally solves the problem of heat dissipation.

On the other hand, it is also possible to introduce the polyoxyalkyleneglycol alkenylethers forming structural group b) and to add the mono- or dicarboxylic acid derivative (structural group a)), so that a uniform distribution of the monomer units over the polymer chain is achieved.

The type of polymerisation initiators, activators and other auxiliaries which are used, for example molecular weight controllers, is relatively straight forward, i.e. the initiators used are the conventional radical donors such as hydrogen peroxide, sodium, potassium or ammonium peroxodisulphate, tert. butylhydroperoxide, dibenzoylperoxide, sodium peroxide, 2,2′-azobis-(2-amidinopropane)-dihydrochloride, azobis-(isobutyronitrile), etc. If redox systems are used, the abovementioned initiators are combined with reducing activators. Examples of such reducing agents include Fe(II)-salts, sodiumhydroxymethanesulphinatedihydrate, alkali metalsulphites and metabisulphites, sodium hypophosphite, hydroxylaminehydrochloride, thiourea, etc.

A particular advantage of the copolymers according to the invention is the fact that they may also be produced without solvent, and this may be carried out using the conventional radical initiators at temperatures between 20 and 150° C. This variant may be employed for economic reasons particularly when the copolymers according to the invention in anhydrous form are to be directly supplied for the use thereof according to the invention, as it is then possible to dispense with a costly separation of the solvent, in particular water (for example by spray drying).

The copolymers according to the invention are outstandingly suitable as an additive for aqueous suspensions of organic and inorganic solids based on mineral or bituminous binders, such as cement, gypsum, lime, anhydrite or other building materials based on calcium sulphate, or based on powder dispersion binders, in which case they are used in a quantity of 0.01 to 10% by weight, in particular from 0.051 to 5% by weight, based on the weight of the mineral binder.

The following examples are provided to explain the invention in more detail.

### EXAMPLES

### Synthesis and Use Examples

### Example 1

A solution consisting of 310 g (0.0258 mol) of vinyloxybutyl-poly-(ethyleneglycol) [average molecular weight 12,000 g/mol] and 350 g of water are introduced at room temperature into a 1 litre double-walled reaction vessel equipped with thermometer, stirrer, pH meter and two inlets for separate feeds.

Outside the reaction vessel, 23.81 g (0.33 mol) acrylic acid and 0.256 g (0.000142 mol) of a monofunctional NH₂-terminated ethylene oxide/propylene oxide-block copolymer (EO4, PO27; molecular weight 1,800 g/mol)=α-butyl- [symbol] -(maleinamido)-poly-(ethyleneglycol)-block-poly(propyleneglycol) started on butanol were diluted with 61.91 g of water.

38.2 g of the acrylic acid-water mixture were added with vigorous stirring and cooling to the vinylpolyether-water solution, followed by a waiting period until the starting temperature of 15° C. was again reached. Thereafter, 0.059 g of iron(II) sulphate-heptahydrate and 0.3 g of 3-mercaptopropanoic acid were added and the pH was adjusted to 5.3 using a 20% NaOH solution. The reaction was started by adding 1.5 g of 30% aqueous hydrogen peroxide. 40.38 g of the acrylic acid solution, to which 3.4 g of 3-mercaptopropanoic acid had been added, were added over a period of 30 minutes. 10 ml of a 6% aqueous solution of Brüggolit™ were added separately within 40 minutes.

After the addition, the solution was adjusted, with stirring, to a pH of 6.5 by adding 24.1 ml of a 20% sodium hydroxide solution. The faintly yellowish coloured, cloudy aqueous polymer solution contained 42.5% of solids. The average molecular weight of the copolymer was 65,700 g/mol.

### Example 2

Example 1 was repeated, but instead of using the vinyloxybutyl-poly(ethyleneglycol) [MW 12,000 g/mol] of that example, a polyether having an average molecular weight of 20,000 g/mol was used.

The example was based on the following required quantities:

| | |
|---|---|
| 16.13 g | (0.224 mol) acrylic acid |
| 350.00 g | (0.0175 mol) vinyloxybutyl-poly-(ethyleneglycol) |
| 0.18 g | (0.0001 mol) α-butyl- ω̅-(maleinamido)-poly- |
| | (ethyleneglycol)-block-poly-(propyleneglycol) |

A light yellow, cloudy aqueous polymer solution was obtained having an average molecular weight of 72,300 g/mol.

### Example 3

The same process was carried out as described in Example 1, except with a significantly increased amount of acrylic acid of 47.62 g (0.66 mol). All the other monomers were used in the same amounts as in Example 1.

After neutralisation with aqueous sodium hydroxide solution, a copolymer solution having an average molecular weight of 60,800 g/mol was obtained.

### Example 4

The amount of acrylic acid used in Example 1 was reduced to a third of the amount used there, i.e. 7.94 g (0.11 mol). A pale yellow polymer solution was obtained having a molecular weight of 58,700 g/mol.

### Example 5

A copolymer was synthesised from the following monomers by the process described in Example 1:

| | |
|---|---|
| 23.81 g | (0.33 mol) acrylic acid |
| 310.00 g | (0.026 mol) vinyloxybutyl-poly-(ethyleneglycol) |
| | with MW = 12,000 g/mol |
| 7.42 g | (0.034 mol) maleic acid-dibutylester |
| 49.0 g | (0.50 mol) maleic acid anhydride |

The resulting brownish aqueous copolymer had an average molecular weight of 36,900 g/mol.

### Example 6

Analogously to Example 1, a copolymer was synthesised which contained 21.84 g (0.195 mol) of itaconic acid anhydride instead of the acrylic acid used in Example 1. The average molecular weight of the end product was 42,300 g/mol.

### Example 7

Example 1 was repeated. In addition to the monomers used therein,

| | |
|---|---|
| 123.2 g | (0.112 mol) methylpoly(ethyleneglycol)-methacrylate |
| | (MW = 1100 g/mol) |

were introduced into the reactor solution together with the acrylic acid/water mixture.

The slightly cloudy aqueous reaction product had an average molecular weight of 69,300 g/mol.

### Example 8

A copolymer (MW 60,000 g/mol) was produced by the process described in Example 1, a mixture of methacrylic acid and acrylic acid (in each case 0.165 mol) was used instead of the acrylic acid.

### Example 9

Instead of the vinyloxybutyl-poly(ethyleneglycol) used in Example 1 having an average molecular weight of 12,000 g/mol, a mixture of 2 vinylethers was used:
Component 1: 204 g (0.017 mol) vinlypolyether-12000
Component 2: 68 g (0.034 mol) vinylpolyether-2000 (vinyloxybutyl-PEG with an average MW of 2000 g/mol)

The two components were mixed with 300 g of water in the receiver. The resulting copolymer had a weight-average molecular weight 59,900 g/mol.

### Example 10

In addition to the vinylether used in Example 1 5.2 g (0.05 mol) of styrene were introduced together with the vinylether. The resulting very cloudy aqueous polymer solution was odour free and had an average molecular weight of 70,600 g/mol.

### Example 11 to 14

The following compounds were used instead of the EO/PO-adduct (copolymer constituent III) used in Example 1:

### Example 11

| | |
|---|---|
| 0.426 g | (0.000213 mol) α, ω̅-bis-(maleinamido)-poly-(propyleneglycol) |
| | (MW 2000 g/mol) |

### Example 12

| | |
|---|---|
| 0.254 g | (0.000169 mol) methyl-poly-(ethyleneglycol)-block-poly- |
| | (propyleneglycol)-allylether (MW = 1500 g/mol, E04, P022) |

### Example 13

| | |
|---|---|
| 0.5 g | (0.00025 mol) α, ω̅-bis-(methacryloyloxy)-poly-(propyleneglycol) |
| | with MW = 2000 g/mol |

### Example 14

| | |
|---|---|
| 4.674 g | (0.019 mol) phthalic acid diallylester |

### Example 15

The following compound was used instead of the vinyl ether used in Example 1:

| | |
|---|---|
| 260 g | (0.02 mol) vinyloxybutyl-polyether-(propyleneglycol)-block-poly- |
| | (ethyleneglycol) [P0 25, E0 250) with MW = 13,000 g/mol. |

The resulting yellowish, very cloudy polymer solution had a molecular weight of 70,300 g/mol.

### Example 16

Example 1 was repeated, except that

| | |
|---|---|
| 85.8 g | (0.66 mol) hydroxypropylacrylate |

were also introduced in addition to the acrylic acid.

The resulting copolymer had a weight-average molecular weight of 74,700 g/mol.

Molar composition of the copolymers according to the invention:

| | Composition (mol %) | | | | Additional |
|---|---|---|---|---|---|
| Examples | I | II | III | IV | component |
| 1 | 92.71 | 7.25 | 0.04 | — | — |
| 2 | 92.72 | 7.24 | 0.04 | — | — |
| 3 | 96.22 | 3.76 | 0.02 | — | — |
| 4 | 80.92 | 18.98 | 0.10 | — | — |
| 5 | 37.08 | 2.92 | 3.82 | 56.18 | — |
| 6 | 88.26 | 11.68 | 0.06 | — | — |
| 7 | 70.52 + 23.93¹⁾ | 5.51 | 0.03 | — | — |
| 8 | 46.36 + 46.36²⁾ | 7.24 | 0.04 | — | — |
| 9 | 86.58 | 4.46 + 8.92²⁾ | 0.04 | — | — |
| 10 | 81.29 | 6.36 | 0.03 | — | 12.32⁴⁾ |
| 11 | 92.69 | 7.25 | 0.06 | — | — |
| 12 | 92.70 | 7.25 | 0.05 | — | — |
| 13 | 92.68 | 7.25 | 0.07 | — | — |
| 14 | 88.05 | 6.88 | 5.07 | — | — |
| 15 | 94.25 | 5.71 | 0.04 | — | — |
| 16 | 32.48 + 64.96⁵⁾ | 2.54 | 0.02 | — | — |

¹⁾Mixture of acrylic acid and MPEG methacrylate-1100 (3:1)
²⁾Mixture of acrylic acid and methacrylic acid (1:1)
3) Mixture of VOBPEG-12000 and VOBPEG-2000 (1:2)
⁴⁾Styrene
⁵⁾Mixture of acrylic acid and hydroxypropylacrylate (1:2)

### Comparative Example

Commercially available high-performance fluidizer (as in PCT/EP00/02251) Glenium ACE 30 produced by Degussa AG

### Use Examples

Prefabricated Concrete Application

10 kg of Portland cement (Bernburger CEM 1 52,5 R (ft)) were mixed according to standards in a concrete forced mixer with 47.2 kg of aggregates (grading curve 0 to 16 mm) and 3.6 kg of water (including the water from the additive). The aqueous solutions of the product according to the invention and of the comparative product respectively were added and the slump was determined according to DIN EN 12350-5 4 and 40 minutes respectively after the beginning of the test.

Table 1 summarises the composition of the concrete mixture:

TABLE 1

| W/Z Value | Cement [kg/m³] | Aggregates [kg/m³] | Water [kg/m³] |
|---|---|---|---|
| 0.37 | 400 | 1887 | 148 |

Following measurement of the slump, samples with edge lengths of 15×15×15 cm were produced and stored at 20° C. The compressive strength was determined after 6, 8 and 10 hours. The air void content of the samples was 1.6% by volume.

The results are provided in Table 2:

TABLE 2

| | | Slump in | | Compressive strength | | |
|---|---|---|---|---|---|---|
| | Proportion | cm after | | in MPa after | | |
| Additive | [% w/w] | 4 min | 40 min | 6 h | 8 h | 10 h |
| Example 1 | 0.21 | 63 | 39 | 3.2 | 15.1 | 27.8 |
| Example 2 | 0.22 | 60 | 38 | 4.9 | 20.6 | 30.9 |
| Example 3 | 0.18 | 67 | 37 | 3.6 | 19.0 | 28.3 |
| Example 4 | 0.24 | 58 | 50 | 2.9 | 13.4 | 26.1 |
| Example 5 | 0.22 | 63 | 45 | 3.1 | 14.2 | 27.9 |
| Example 6 | 0.21 | 57 | 50 | 3.1 | 13.8 | 29.9 |
| Example 7 | 0.22 | 59 | 53 | 4.0 | 20.0 | 30.1 |
| Example 8 | 0.21 | 62 | 40 | 3.3 | 15.7 | 25.9 |
| Example 9 | 0.20 | 63 | 51 | 4.0 | 19.3 | 26.8 |
| Example 10 | 0.21 | 62 | 39 | 4.2 | 14.3 | 27.9 |
| Example 11 | 0.22 | 63 | 40 | 3.3 | 15.0 | 27.7 |
| Example 12 | 0.21 | 62 | 41 | 3.5 | 15.2 | 29.0 |
| Example 13 | 0.21 | 64 | 43 | 3.7 | 14.6 | 28.1 |
| Example 14 | 0.20 | 59 | 42 | 3.0 | 13.9 | 28.0 |
| Example 15 | 0.22 | 62 | 46 | 3.4 | 15.9 | 29.9 |
| Example 16 | 0.26 | 58 | 57 | 3.1 | 14.3 | 27.9 |
| Comparative | 0.22 | 52 | 30 | 2.0 | 9.4 | 25.0 |
| Example 1 | | | | | | |

4.3 kg of Portland cement (Bernburger CEM 1 52,5 R (ft)) were mixed according to standards in a concrete forced mixer with 20.1 kg of aggregates (grading curve 0. to 16 mm) and 1.6 kg of water (including the water from the additive). The aqueous solutions of the product according to the invention and of the comparative product respectively were added and the slump was determined according to DIN EN 12350-5 4 minutes after the start of the test.

Table 3 summarises the composition of the concrete mixture:

TABLE 3

| W/Z Value | Cement [kg/m³] | Aggregates [kg/m³] | Water [kg/m³] |
|---|---|---|---|
| 0.39 | 400 | 1865 | 156 |

Following measurement of the slump, samples having an edge length of 10×10×10 cm were produced and stored at 10° C. The compressive strength was determined after 10, 12 and 16 hours. The air void content of the samples was 1.6% by volume.

The results are provided in Table 4:

| | | Slump in | | Compressive strength | | |
|---|---|---|---|---|---|---|
| | Proportion | cm after | | in MPa after | | |
| Additive | [% w/w] | 4 min | 40 min | 10 h | 12 h | 16 h |
| Example 1 | 0.16 | 69 | 56 | 3.5 | 6.9 | 14.8 |
| Example 2 | 0.18 | 65 | 55 | 3.9 | 8.9 | 17.8 |
| Example 3 | 0.14 | 68 | 50 | 3.9 | 7.5 | 14.7 |
| Example 4 | 0.20 | 64 | 60 | 2.9 | 6.0 | 12.8 |
| Example 5 | 0.18 | 68 | 58 | 3.5 | 6.7 | 14.1 |
| Example 6 | 0.17 | 63 | 58 | 3.3 | 6.8 | 14.7 |
| Example 7 | 0.20 | 65 | 63 | 3.3 | 6.1 | 13.7 |
| Example 8 | 0.16 | 63 | 53 | 3.6 | 6.7 | 14.3 |
| Example 9 | 0.15 | 66 | 54 | 3.6 | 6.8 | 15.3 |
| Example 10 | 0.16 | 64 | 53 | 3.9 | 7.3 | 16.7 |
| Example 11 | 0.19 | 65 | 56 | 3.5 | 6.8 | 15.0 |
| Example 12 | 0.16 | 64 | 59 | 3.6 | 7.0 | 17.0 |
| Example 13 | 0.16 | 62 | 53 | 3.7 | 7.1 | 15.0 |
| Example 14 | 0.15 | 60 | 50 | 3.4 | 7.0 | 14.3 |
| Example 15 | 0.18 | 65 | 56 | 4.0 | 8.0 | 15.0 |
| Example 16 | 0.20 | 62 | 58 | 3.6 | 7.2 | 16.9 |
| Comparative | 0.20 | 62 | 49 | 1.9 | 3.9 | 9.8 |
| Example 1 | | | | | | |

1-19. (canceled)

20. A copolymer based on unsaturated mono- or dicarboxylic acid derivatives and oxyalkyleneglycol-alkenyl ethers, comprising
a) from 25 to 98.99 mol % of a structural group of at least one of formula Ia, Ib or Ic 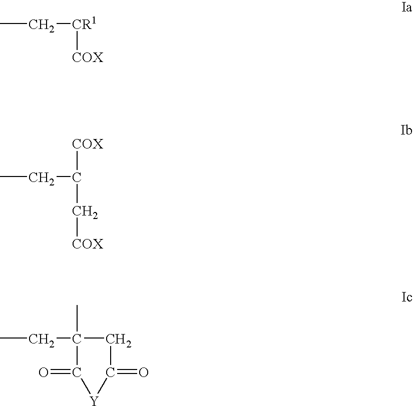
wherein R¹ is hydrogen or an aliphatic hydrocarbon radical having from 1 to 20 C atoms;
X is —OMₐ, —O—(CₘH₂ₘO)ₙ—R², or —NH—(CₘH₂ₘO)ₙR²;
M is hydrogen, a mono-or divalent metal cation, an ammonium ion, or an organic amine radical;
a is ½ or 1;
R² is hydrogen, an aliphatic hydrocarbon radical having from 1 to 20 C atoms, a cycloaliphatic hydrocarbon radical having from 5 to 8 C atoms, or an optionally substituted aryl radical having from 6 to 14 C atoms
Y is O or NR²;
m is from 2 to 4; and
n is from 0 to 200;
b) from 1 to 48.9 mol % of the structural group of formula II 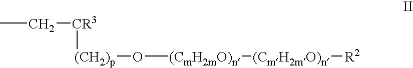
wherein R³ is hydrogen or an aliphatic hydrocarbon radical having from 1 to 5 C atoms;
m′ is 2 to 4
n′+n″ is from 250 to 500
p is from 0 to 3; and
R² and m are as defined above;
c) from 0.01 to 6 mol % of a structural group from formula IIIa or IIIb 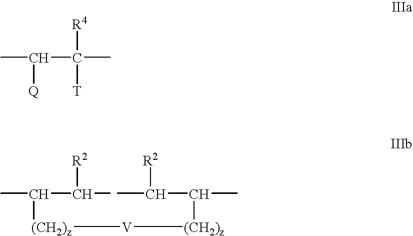
wherein Q is —H, —COOMₐ, or —COOR⁵;
T is 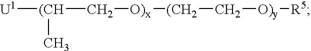
—(CH₂)_{z}—V—(CH₂)_{z}—CH═CH—R².
or —COOR⁵ when Q is —COOR⁵ or —COOMₐ;
U¹ is —CO—NH—, —O—, or CH₂O—;
U² is —NH—CO—, —O—, or —OCH₂—;
V is —O—CO—C₆H₄—CO—O;
R⁴ is H or CH₃
R⁵ is an aliphatic hydrocarbon radical having from 3 to 20 C atoms, a cycloaliphatic hydrocarbon having from 5 to 8 C atoms, or an aryl radical having from 6 to 14 C atoms;
R⁶═R² or 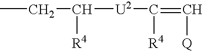
z is from 0 to 4;
x is from 1 to 150; and
y is from 0 to 15,
and;
d) from 0 to 60 mol of structural groups of formula IVa or IVb 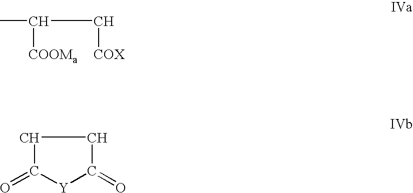
wherein a, M, X and Y are as defined above.

21. A copolymer according to claim 20, wherein R¹ is a methyl radical.

22. A copolymer according to claim 20, wherein M is a mono- or divalent metal cation selected from the group consisting of sodium, potassium, calcium and magnesium.

23. A copolymer according to claim 20, wherein R² is phenyl, the phenyl radical is further substituted by hydroxyl, carboxyl or sulphonic acid groups.

24. A copolymer according to claim 20, wherein n is 1 to 150.

25. A copolymer according to claim 20, wherein p is 0 and m is 2.

26. A copolymer according to claim 20, comprising from 70 to 94.98 mol % of a structural group of at least one of formula Ia, Ib; or Ic, from 5 to 25 mol % of a structural group of formula II; from 0.02 to 2 mol % of at least one of the structural groups of formula IVa or IVb; and from 0 to 24.98 mol % of a structural group of at least one of formula IVa or IVb.

27. A copolymers according to claim 20, further comprising up to 50 mol % based on the total of the structural groups of formulae I, II, III and IV, of a monomer of a vinyl or (meth)acrylic acid derivative.

28. A copolymers according to claim 27, wherein said monomer is at least one member selected from the group consisting of styrene, α-methlystyrene, vinyl acetate, vinyl propionate, ethylene, propylene, isobuteane, N-vinylpyrrolidone, allylsulphonic acid, methallylsulphonic acid, vinyl sulphonic acid and vinyl phosphonic acid.

29. A copolymer according to claim 28, wherein said monomer is selected from the group consisting of hydroxyalkyl(meth)acrylate, acrylamide, methacrylamide, AMPS, methylmethacylate, methylacrylate, butylacrylate and cyclohexylacrylate.

30. A copolymer according to claim 20 having an average molecular weight of from 1,000 to 100,000 g/mol.

31. A process for the production of a copolymer according to claim 20 comprising polymerizing from 25 to 98.99 mol % of an unsaturated mono- or diocarboxylic acid derivative; from 1 to 48.9 mol % of an oxyalkyleneglycol alkenylether; 0.01 to 6 mol % of a vinyl polyalkyleneglycol compound or ester compound and from 0 to 60 mol % of a dicarboxylic acid derivative using a radical initiator to form the copolymer.

32. A process according to claim 31, comprising polymerizing from 70 to 94.88 mol % of said unsaturated mono- or diocarboxylic acid derivative, from 5 to 25 mol % of said oxyalkyleneglycol alkenylether, from 0.02 to 2 mol % of said vinyl polyalkyleneglycol compound or ester compound and from 0 to 24.98 mol % of said dicarbocyclic acid derivative.

33. A process according to claim 31 wherein up to 50 mol % based on the monomers with the structural groups according to the formulae I, II, III and IV, of a vinyl- or (meth)acrylic acid derivative are also copolymerized.

34. A process according to claim 31, wherein the polymerization is carried out in aqueous solution at a temperature of from 20 to 100° C.

35. A process according to claim 34 wherein the concentration of said aqueous solution is from 30 to 50% by weight.

36. A process according to claim 31, wherein the polymerization is carried out without solvent using a radical initiator at a temperature of from 20 to 150° C.

37. An aqueous suspension comprising the copolymer of claim 20 and water.

38. The aqueous suspension of claim 37, wherein said copolymer is present in an amount of from 0.01 to 10% by weight.
